(19) United States
(12) Patent Application Publication
(10) Pub. No.: US 2009/0158212 A1
(43) Pub. Date: Jun. 18, 2009

(54) SYSTEM AND METHOD FOR PRESENTING RECENTLY-USED AND IN-USE APPLICATIONS FOR EASE OF NAVIGATION ON AN ELECTRONIC DEVICE

(75) Inventors: Elizabeth Dykstra-Erickson, San Francisco, CA (US); Eric Bergman, Menlo Park, CA (US); Tom Lloyd, San Francisco, CA (US); Jesse E. Donaldson, Santa Clara, CA (US); Gabriel C. Dalbec, San Jose, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/025,755

(22) Filed: Feb. 5, 2008

Related U.S. Application Data
(60) Provisional application No. 60/888,527, filed on Feb. 6, 2007.

(51) Int. Cl. G06F 3/048

(52) U.S. Cl. 715/811

(57) ABSTRACT

A system and method of providing a user interface jump list application is disclosed, which reduces multiple functions into a single user interface function for electronic devices such as portable or mobile devices having computing and communication capabilities. First, the user interface jump list application provides a list of applications executing in the background on the electronic device. Second, the user interface application provides for the ability for the user to close, kill or quit (by giving an instruction) the application running in the background without having to activate or launch that application. The user interface application indicates applications that are active in a different font so the user can easily differentiate an application that is active from one that is not. The user interface application additionally provides a list of important or favorite applications for quick access and a list of recently used applications for quick access. A user can easily launch an application from this list.

### CROSS-REFERENCE TO RELATED APPLICATIONS

This application claims the benefit under 35 U.S.C. § 119(e) of U.S. Provisional Patent Application No. 60/888,527 filed on Feb. 6, 2007, entitled “Method for Representing Recently-Used and In-Use Applications for Navigation on a Mobile Device,” which is herein incorporated by reference.

### FIELD OF THE INVENTION

The present invention generally relates to systems and methods for user interface navigation on electronic devices such as mobile or portable telephonic or computing devices and more particularly, to a system and method for presenting recently-used and in-use applications in a format that permits easy navigation on an electronic device.

### BACKGROUND OF THE INVENTION

Generally, a common method for accessing computer programs or applications, especially on mobile handheld devices, is via accessing a list of applications or icons, or groups of icons displayed on a display screen of the mobile handheld device. However, given the limited input mechanisms that presently exist in mobile handheld devices, accessing a single application from a long list or group of icons can be a time-consuming and imprecise task, often leaving the user frustrated.

User interfaces ideally provide users a second way to access a selection of frequently used applications, without requiring them to navigate to standard locations in the system. The user can create and manage shortcuts, either via menu items, icons, buttons, or lists in other areas of the system.

Completing various tasks on an electronic device such as a mobile phone often requires the use of multiple applications, requiring the user to launch, switch, and exit applications frequently. This typically requires many navigation steps because the available screen space does not permit repeating access points on each screen. Thus, another system and method of providing redundant access to application management is needed that would minimize both the number of navigation steps and the use of screen space.

Electronic devices such as portable or mobile devices typically have limited screen space and are limited in the configurations of input buttons that are available. Therefore, there is not enough space to provide enable shortcuts, recent application lists, a background application switcher or an application killer, as separate applications and user interfaces.

Therefore, there is a need for a method of efficiently managing applications, both in the foreground (ahead of the current) and the background, (behind the current) on an electronic device. Additionally, there is a need for a user to be able to easily switch for use between applications that are currently being executed on the electronic device. Further, there is a need for an easy method for switching back to recently run applications and displaying frequently used applications.

These and other advantages may be provided by various embodiments of the present invention that are illustrated and discussed below.

### SUMMARY OF THE INVENTION

The present invention provides a user interface application providing “jump list” operations to a user, which indicates multiple functions in a single user interface on an electronic device. This new user interface application is referred to here as a “jump list” application. First, the jump list application provides a list of applications executing in the background on the mobile device. Second, the jump list application enables the user to close or kill the application running in the background (by giving an instruction) without launching that application. The jump list application additionally provides a list of important or favorite applications for quick access and a list of recently used applications for quick access. The jump list application shows active applications in a different font from those applications which are not active to allow the user to easily discern at a quick glance which application is active. In a further aspect, the user can also customize the jump list and arrange it in a tab format.

Additional features and advantages of the invention will be set forth in the description which follows, and in part will be obvious from the description, or may be learned by practice of the invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an exemplary electronic device (for example a portable or mobile device with computing and/or telephonic capabilities) for use of the present invention;

FIG. 2 is a front view of the electronic device, which may be used with the present invention and embodies the system illustrated in FIG. 1.

FIGS. 3 through 6 are front view of the electronic device shown in FIGS. 1 and 2, illustrating displays of exemplary embodiments of the “jump list” user interface application in accordance with an exemplary embodiment of the present invention;

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

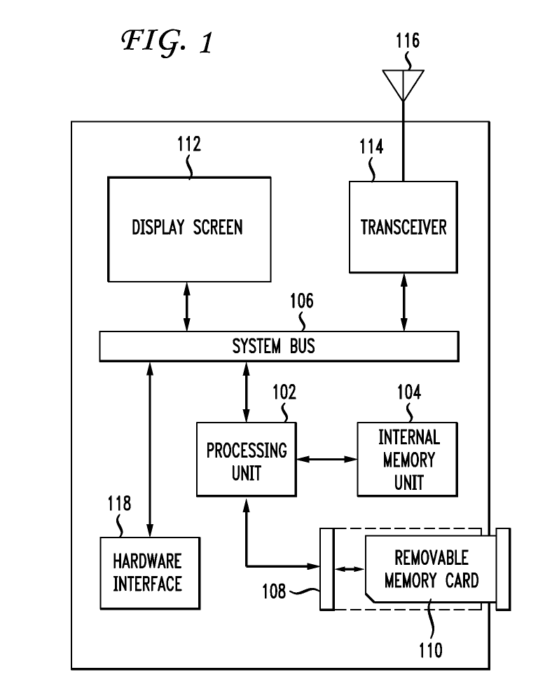

FIG. 1 shows elements of an electronic device, for example a portable or mobile device 100 embodied in accordance herewith for executing systems and methods of the present invention. This electronic device may comprise a portable computer, a personal digital assistant (PDA), and enhanced cell phone, or any other computer system having a relatively small display screen, and preferably having wireless or other communication capability. The mobile device 100 includes a processing unit, 102, adapted to run an operating system platform and application programs. The processing unit 102 is also adapted to control other complements of the mobile device as explained herein. An internal memory unit, 104, may comprise a read-only memory (ROM) to store critical files and a random access memory (RAM) to store other files as needed. The electronic or mobile device of FIG. 1 may also include a removable memory card interface 108 as to accommodate the memory card 110.

A display screen 112 is coupled to the processing unit 102 through a bus 106 and thereby receives input from the processing unit 102 that provides displays on the screen 112. The system of FIG. 1 also includes a transceiver unit 114, coupled to an antenna 116 and to the processing unit 102. The transceiver 114 provides for transmission and reception of wireless signals over a designated range of frequencies, allowing the mobile device to establish connections with external devices and networks, such as a wireless telephone network or the internet. Data received from external sources via the transceiver 114, such as media content obtained from an online depot may be delivered via the bus 106 to the processing unit 102 and thereafter stored in the available memory. As depicted in FIG. 1, a hardware interface 118 is coupled to a keypad or switches on the body of the mobile device 100.

The invention provides an application user interface (implemented in software or hardware or both) enabling multiple functions in a single user interface for mobile devices as depicted in FIG. 1. Accordingly, a system and method for handling network activation between a computer and a carrier is disclosed. Numerous specific details are set forth here in order to provide a comprehensive understanding of the present invention. It will be understood, however, by one skilled in the art, that the present invention may be practiced without some or all of the details that are disclosed here.

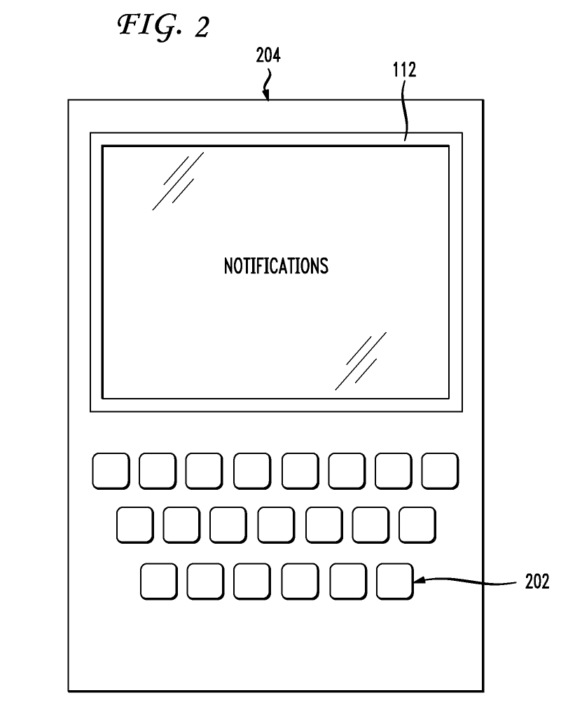

A computer that includes wireless network technology includes a processing device for executing applications and an operating system. An exemplary computer as depicted in FIG. 1 may take physical form of the device depicted in FIG. 2.

Referring now to FIG. 2, a keypad 202 is illustrated along with the display screen 112 contained in a housing 204 to represent an electronic such as a mobile device for use in accordance with the present invention. On such a mobile device, a brief overview of the basic functions of the method of providing a user interface for presenting recently-used and in-use applications for navigation are illustrated. A “jump list” application provides four functions in a single user interface for mobile devices. First, the jump list application provides a list of applications executing in the background on the mobile device. Second, the jump list application provides the ability for the user to close or kill the application running in the background without launching the particular application the user wants to quit. The jump list application additionally provides a list of important or favorite applications for quick access. Finally, the jump list application also provides a list of recently used applications for quick access. In addition, the jump list shows active applications in a different font from those that are not active, thereby allowing the user at a quick glance to determine an active application. The jump list can be customized by the user and arranged in a tab format or as desired by the user.

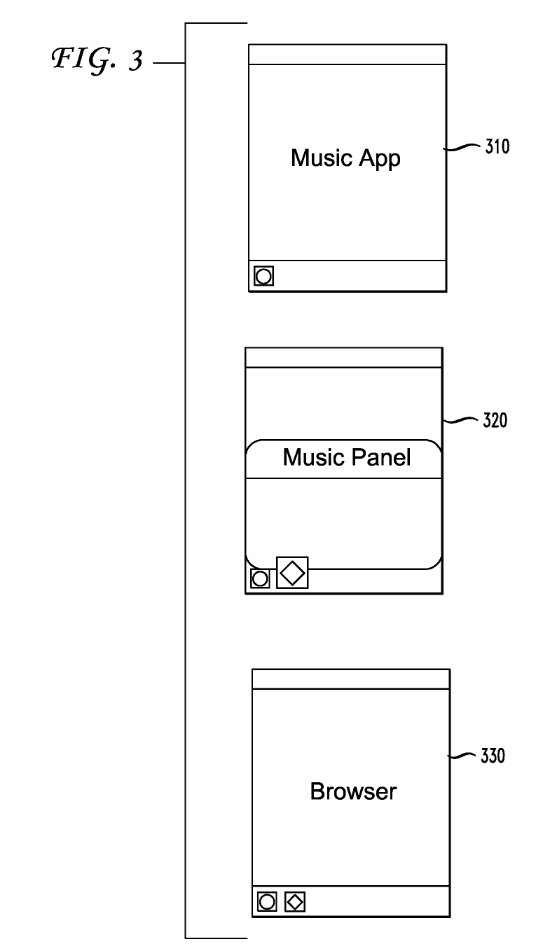

One or more items in such a list can be locked by the operator for fast navigation access to an operator-defined link, process, or application. Referring now to FIG. 3, there is shown exemplary screen representations of the user interfaces in accordance with the principles of the invention. A user may launch a “music player” application on the electronic (mobile or computing) device and “playback progress” is shown as indicated by reference numeral 310. The music panel is transient and its icon is displayed in the music panel until playback of the music is terminated. While the music is playing, the user may launch a “browser” to catch up on the news. The “browser” is now the foreground activity and the “music player” is the background activity as illustrated by reference numeral 330.

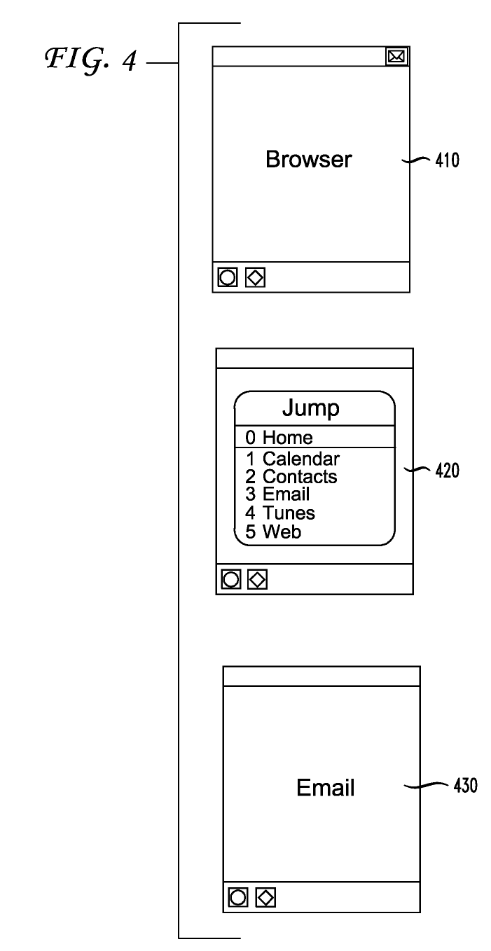

Referring now to FIG. 4, there is shown further exemplary screen representations of the user interfaces in accordance with the principles of the invention. In this example illustrated here, while the user is using the “browser” in the foreground and listening to the “music player” in the background, a notification of a “new electronic mail message” may be received as illustrated by reference numeral 410. The notification icon for a new electronic mail message is displayed in the upper right of the screen. The user then has the option of using the jump list to return to the application launcher and then selecting the electronic mail message in 420. The user also has the option of using the back key to return to the launcher and then select the electronic mail message. The user also has the option of selecting from the most recently used application list if the user has selected the electronic mail message recently.

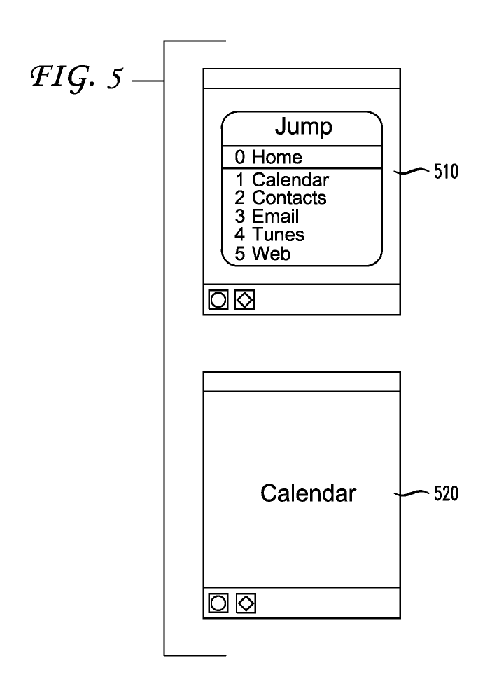

Once the user switches back to the electronic mail application, the “browser” application saves its state and closes. Then the “electronic mail” application and the “music player” application are active as illustrated by reference numeral 430. Referring now to FIG. 5, there is shown a further display of the exemplary embodiment involving the principles of the invention. If the user wishes to check a “calendar” application for a quick look at his or her schedule, the user may select the calendar application as illustrated by reference numerals 510 and 520.

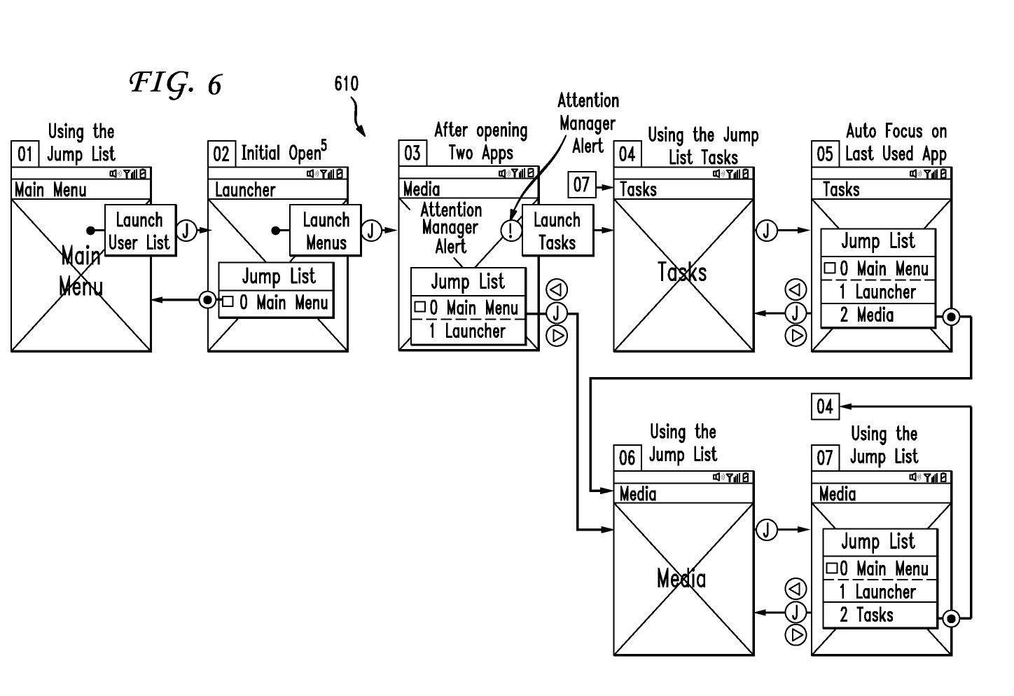

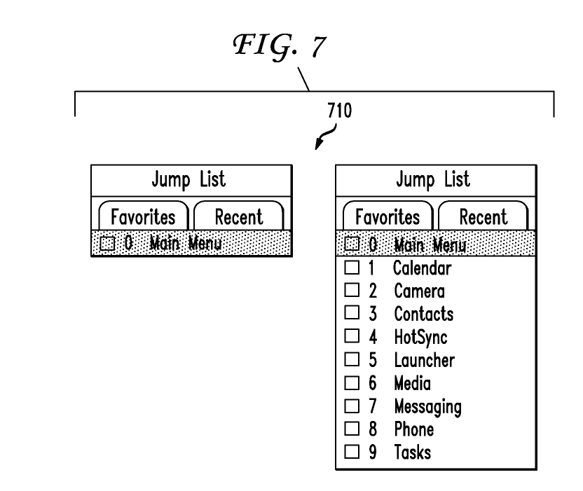

Referring now to FIG. 6, there is shown an alternative set of displays of the jump list application in accordance with the principles of the present invention. FIG. 6 illustrates generally at 610 a user switching between applications with the jump list application appearing between switching from application to application.

Referring now to FIG. 7, there is shown an alternative display embodiment of the jump list application in accordance with the principles of the present invention. The exemplary display 710 shows an expansion of the jump list application by use of tabs to demonstrate examples of recently-used and favorite applications. Additional examples of alternative embodiments include using multiple tabs to represent multiple pages of favorite applications.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for displaying recently used and in use applications for an electronic device, comprising the steps of:
compiling a first list of applications that are operating in the foreground and background of the electronic device;
compiling a second list of applications preselected by the user of the electronic device as favorite applications;
displaying said first list of applications and the second list of applications upon activation by the user of the electronic device; and
switching directly to an application upon selection by the user.

2. The method of claim 1, wherein the displaying step is performed using tabs on a display of the electronic device.

3. The method of claim 1, further comprising the step of:
displaying a notification upon activation by an operating system of the mobile device.

4. The method of claim 3, further comprising the step of:
switching to the notification upon selection by the user.

5. The method of claim 4, further comprising the step of:
switching back to the application running in the background upon selection by the user.

6. The method of claim 4, further comprising the step of:
switching back to the application running in the foreground upon selection by the user.

7. The method of claim 4, further comprising the step of:
switching back to the second list upon selection by the user.

8. A graphical interface for users of an electronic device for displaying to users recently used and in use applications on the electronic device, comprising:
a first list of applications running in the foreground and background;
a second list of applications preselected as favorite applications;
a display for displaying the first list and the second list upon activation by a user of the mobile device;
a switching capability for switching directly to an application upon selection by the user.

9. The graphical interface of claim 8, wherein the display comprises a plurality of tabs.

10. The graphical interface of claim 8, wherein the display displays a notification upon activation by an operating system of the electronic device.

11. The graphical interface of claim 10, wherein the display displays switching to the notification upon selection by the user.

12. The graphical interface of claim 11, wherein the display displays switching back to the application running in the background upon selection by the user.

13. The graphical interface of claim 11, wherein the display displays switching back to the application running in the foreground upon selection by the user.

14. The interface of claim 11, wherein the display displays switching back to the second list upon selection by the user.
